(19) United States
(12) Patent Application Publication
(10) Pub. No.: US 2019/0205059 A1
(43) Pub. Date: Jul. 4, 2019

(54) DATA STORAGE APPARATUS AND OPERATING METHOD THEREOF

(71) Applicant: SK hynix Inc., Gyeonggi-do (KR)

(72) Inventor: Young Ick CHO, Seoul (KR)

(21) Appl. No.: 16/052,276

(22) Filed: Aug. 1, 2018

(30) Foreign Application Priority Data
Jan. 3, 2018 (KR) 10-2018-0000735

(51) Int. Cl. G06F 3/06

(52) U.S. Cl. CPC G06F 3/0656; G06F 3/0659; G06F 3/0679; G06F 3/0604

(57) ABSTRACT

A data storage apparatus includes a nonvolatile memory device, a command queue configured to queue one or more normal commands and an abort command, a data buffer configured to temporarily store write data which is to be transmitted from the host apparatus to the nonvolatile memory device and read data which is read out from the nonvolatile memory device and is to be transmitted to the host apparatus, an abort handler configured to perform abort handling with respect to a normal command corresponding to the abort command among the normal commands, and a processor configured to instruct the abort handler to perform the abort handling before the normal commands are transmitted to the nonvolatile memory device.

### CROSS-REFERENCES TO RELATED APPLICATION

The present application claims priority under 35 U.S.C. § 119(a) to Korean patent application number 10-2018-0000735, filed on Jan. 3, 2018, which is incorporated herein by reference in its entirety.

### BACKGROUND

### 1. Technical Field

Various embodiments may generally relate to a semiconductor apparatus, and, more particularly, to a data storage apparatus and an operating method thereof.

### 2. Related Art

In recent years, the paradigm for computer environments changed to ubiquitous computing which may be used everywhere and at any time. As a result, use of portable electronic apparatuses such as a mobile phone, a digital camera, and a laptop computer has been increasing rapidly. Generally, portable electronic apparatuses use data storage apparatuses that employ memory devices for storing data used in the portable electronic apparatuses.

Data storage apparatuses using memory devices have no mechanical driving units and exhibit good stability and endurance, fast information access rate, and low power consumption. Such data storage apparatuses may include a universal serial bus (USB) memory device, a memory card having various interfaces, a universal flash storage (UFS) device, a solid-state drive (SSD), and the like. Due to consumer demand for improved electronic devices, the capabilities and performance of data storage apparatuses employed in such devices needs to be further improved.

### SUMMARY

Embodiments of the present invention are provided including a data storage apparatus that is capable of preventing a malfunction and an operating method thereof.

In an embodiment of the present disclosure, a data storage apparatus may include: a nonvolatile memory device; a command queue configured to queue one or more normal commands and an abort command; a data buffer configured to temporarily store write data which is to be transmitted from the host apparatus to the nonvolatile memory device and read data which is read out from the nonvolatile memory device and is to be transmitted to the host apparatus; an abort handler configured to perform abort handling with respect to a normal command corresponding to the abort command among the normal commands; and a processor configured to instruct the abort handler to perform the abort handling before the normal commands are transmitted to the nonvolatile memory device.

In an embodiment of the present disclosure, an operating method of a data storage apparatus, the method may include: instructing an abort handler to perform abort handling; determining whether or not a queued abort command is present by scanning a command queue through the abort handler; performing the abort handling with respect to a normal command corresponding to the abort command among normal commands through the abort handler; and providing a report that the abort handling is completed to a controller through the abort handler.

In an embodiment of the present disclosure, a controller for controlling a memory system, the controller include: a command queue suitable for queueing one or more commands; a data buffer suitable for buffering data corresponding to the commands; a command buffer suitable for buffering one or more commands; and a processor suitable for rearranging the queued commands in the command queue; de-queueing the rearranged commands to the command buffer; outputting the buffered commands to control a memory device to perform an operation; deleting one or more among the queued commands, the rearranged commands and the buffered commands indicated by an abort command; and deleting the buffered data corresponding to the deleted commands.

In accordance with various embodiments of the present invention, a controller may determine a point of time that the abort handling for an abort command transmitted from a host apparatus is to be performed and thus the operation synchronization between various function modules inside the controller or various function modules inside the nonvolatile memory device may be prevented from being broken.

These and other features, aspects, and embodiments are described below in the section entitled “DETAILED DESCRIPTION.”

### BRIEF DESCRIPTION OF THE DRAWINGS

The above and other aspects, features and advantages of the subject matter of the present disclosure will be more clearly understood from the following detailed description taken in conjunction with the accompanying drawings, in which:

FIG. 1 is simplified block diagram illustrating a configuration example of a data storage apparatus in accordance with an embodiment of the present disclosure;

FIG. 2 is simplified diagram illustrating a command transmission process in accordance with an embodiment of the present disclosure;

FIGS. 3A and 3B are simplified diagrams illustrating examples that a location that an abort-requested command is deleted is changed according to an abort handling instruction timing in accordance with an embodiment of the present disclosure;

FIG. 4 is a simplified diagram illustrating an example that write data corresponding to a write command is stored in a data buffer in accordance with an embodiment of the present disclosure;

FIG. 5 is a simplified diagram illustrating an example that data stored in a data buffer is deleted and an index is changed in performing abort handling in accordance with an embodiment of the present disclosure;

FIG. 6 is a flowchart illustrating an operating method of a data storage apparatus in accordance with an embodiment of the present disclosure;

FIG. 7 is a detailed flowchart illustrating a process of performing abort handling in FIG. 6;

FIG. 8 is a simplified diagram illustrating an example of a data processing system including a solid-state drive (SSD) in accordance with an embodiment of the present disclosure;

FIG. 9 is a simplified diagram illustrating an example of a controller illustrated in FIG. 8;

FIG. 10 is a simplified diagram illustrating an example of a data processing system including a data storage apparatus in accordance with an embodiment of the present disclosure;

FIG. 11 is a simplified diagram illustrating an example of a data processing system including a data storage apparatus in accordance with an embodiment of the present disclosure;

FIG. 12 is a simplified diagram illustrating an example of a network system including a data storage apparatus in accordance with an embodiment of the present disclosure; and

FIG. 13 is simplified block diagram illustrating an example of a nonvolatile memory device included in a data storage apparatus in accordance with an embodiment of the present disclosure.

### DETAILED DESCRIPTION

Various embodiments of the present invention will be described in greater detail with reference to the accompanying drawings. The drawings are simplified schematic illustrations of various embodiments (and intermediate structures). As such, variations from the configurations and shapes of the illustrations as a result, for example, of manufacturing techniques and/or tolerances, are to be expected. Thus, the described embodiments should not be construed as being limited to the particular configurations and shapes illustrated herein but may include deviations in configurations and shapes which do not depart from the spirit and scope of the present invention as defined in the appended claims.

The present invention is described herein with reference to cross-section and/or plan illustrations of idealized embodiments of the present invention. However, embodiments of the present invention should not be construed as limiting the inventive concept. Although a few embodiments of the present invention will be shown and described, it will be appreciated by those of ordinary skill in the art that changes may be made in these embodiments without departing from the principles and spirit of the present invention.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The phrase “at least one of . . . and . . . ,” when used herein with a list of items, means a single item from the list or any combination of items in the list. For example, “at least one of A, B, and C” means, only A, or only B, or only C, or any combination of A, B, and C.

The term “or” as used herein means either one of two or more alternatives but not both nor any combinations thereof.

As used herein, the term “and/or” includes any and all combinations of one or more of the associated listed items.

As used herein, singular forms are intended to include the plural forms as well, unless the context clearly indicates otherwise.

It will be further understood that the terms “includes,” and “including” are used interchangeably in this specification with the open-ended terms “comprises,” and “comprising,” to specify the presence of any stated elements and to not preclude the presence or addition of one or more other non-stated elements.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

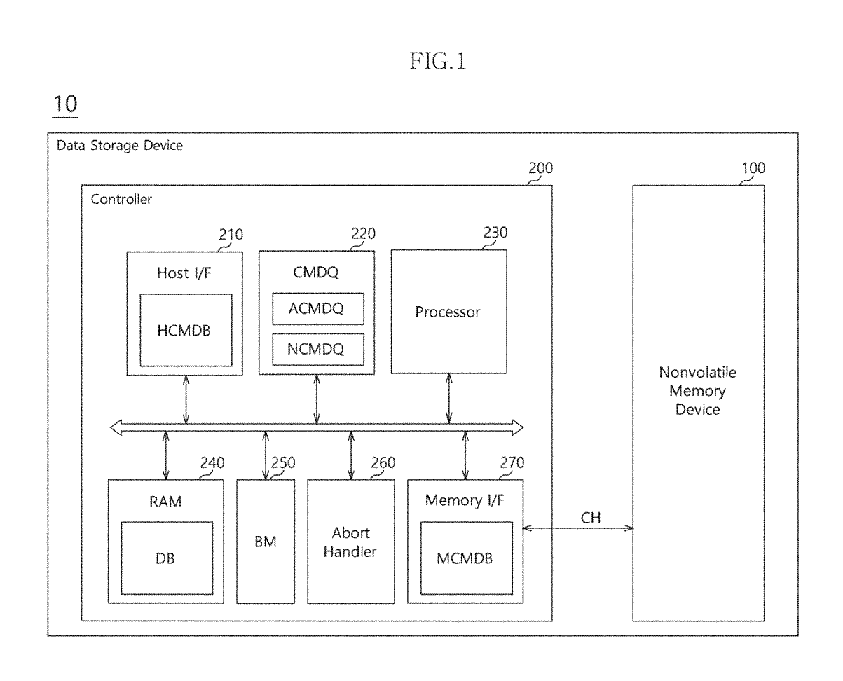

FIG. 1 is simplified block diagram illustrating a configuration example of a data storage apparatus 10 in accordance with an embodiment. The data storage apparatus 10 in accordance with the embodiment may store data to be accessed by a host apparatus (not shown) such as a mobile phone, an MP3 player, a laptop computer, a desktop computer, a game player, a television (TV), or an in-vehicle infotainment system, and the like. The data storage apparatus 10 may also be referred to herein as a memory system.

The data storage apparatus 10 may be manufactured as any one among various types of storage apparatuses which can be coupled via a suitable host interface employing a transfer protocol with a host apparatus (not shown). For example, the data storage apparatus 10 may be configured as any one of various types of storage apparatuses, such as a solid-state drive (SSD), a multimedia card in the form of an MMC, an eMMC, an RS-MMC, and a micro-MMC, a secure digital card in the form of an SD, a mini-SD, and a micro-SD, a universal serial bus (USB) storage device, a universal flash storage (UFS) device, a personal computer memory card international association (PCMCIA) card type storage device, a peripheral component interconnection (PCI) card type storage device, a PCI-express (PCI-E) card type storage device, a compact flash (CF) card, a smart media card, a memory stick, and the like.

The data storage apparatus 10 may be manufactured as any one among various types of packages. For example, the data storage apparatus 10 may be manufactured as any one of various types of packages, such as a package on package (POP), a system in package (SIP), a system on chip (SOC), a multi-chip package (MCP), a chip on board (COB), a wafer-level fabricated package (WFP), and a wafer-level stack package (WSP).

Referring to FIG. 1, the data storage apparatus 10 may include a nonvolatile memory device 100 and a controller 200.

The nonvolatile memory device 100 may be operated as a storage medium of the data storage apparatus 10. The nonvolatile memory device 100 may include any one of various types of nonvolatile memory devices, such as a NAND flash memory device, a NOR flash memory device, a ferroelectric random-access memory (FRAM) using a ferroelectric capacitor, a magnetic random-access memory (MRAM) using a tunneling magneto-resistive (TMR) layer, a phase-change random-access memory (PRAM) using a chalcogenide alloy, and a resistive random-access memory (RERAM) using a transition metal compound.

Although the nonvolatile memory device 100 is illustrated as one block in FIG. 1, the nonvolatile memory device 100 may include a plurality of dies, each die including a plurality of memory blocks.

The nonvolatile memory device 100 may include a memory cell array including a plurality of memory cells (not shown) arranged in regions in which a plurality of word lines (not shown) and a plurality of bit lines (not shown) cross each other. The memory cell array may include a plurality of memory blocks and each of the plurality of memory blocks may include a plurality of pages.

For example, each of the memory cells in the memory cell array may be at least one among a single level cell (SLC) in which a single bit data (for example, 1-bit data) is stored, a multilevel cell (MLC) in which 2-bit data is stored, a triple level cell (TLC) in which 3-bit data is stored, and a quad level cell QLC in which 4-bit data is stored. The memory cell array may include one or more cells among the SLC, the MLC, the TLC, and the QLC. The memory cell array may is include memory cells arranged in a two-dimensional (2D) horizontal structure or in a three-dimensional (3D) vertical structure.

The controller 200 may include a host interface 210, a command queue (CMDQ) 220, a processor 230, a random-access memory (RAM) 240, a buffer manager (BM) 250, an abort handler 260, and a memory interface 270.

The host interface 210 may perform interfacing between a host apparatus (not shown) and the data storage apparatus 10. For example, the host interface 210 may communicate with the host apparatus through a suitable transfer protocol including, for example, a USB protocol, a UFS protocol, an MMC protocol, a parallel advanced technology attachment (PATA) protocol, a serial advanced technology attachment (SATA) protocol, a small computer system interface (SCSI) protocol, a serial attached SCSI (SAS) protocol, a PCI protocol, a PCI-E protocol and the like.

The host interface 210 may include a host command buffer HCMDB for temporarily storing commands such as a read command, a write command, an unmap command, and the like transmitted from a host apparatus. The host command buffer HCMDB may be configured to have a first input first output (FIFO) structure.

The command queue 220 may include a normal command queue NCMDQ and an abort command queue ACMDQ. Normal commands among the commands temporarily stored in the host command buffer HCMDB may be queued in the normal command queue NCMDQ. The normal commands may refer to commands which request performing of operations with respect to the nonvolatile memory device 100, for example, a read operation, a write operation, an unmap operation, and the like. For example, a normal command may include any command which requests an operation to be performed in the nonvolatile memory device 100. An abort command may refer to a command which requests abort of the operation to be performed according to an arbitrary normal command among the previously transmitted normal commands.

The normal commands and abort commands stored in the host command buffer HCMDB of the host interface 210 may be queued into the normal command queue NCMDQ and the abort command queue ACMDQ of the command queue 220, respectively, through the control of the processor 230.

The processor 230 may be configured as a micro control unit (MCU) or a central processing unit (CPU). The processor 230 may process a command (for example, read command, write command, unmap command, and the like) transmitted from a host apparatus. To process the command transmitted from the host apparatus, the processor 230 may drive a code-type instruction or algorithm (for example, software) loaded into the RAM 240. The processor 230 may control internal function blocks and the nonvolatile memory device 100.

When an abort command is received from a host apparatus, the processor 230 may allow the received abort command to be queued into the abort command queue ACMDQ of the command queue 220 and may not abort a currently performed operation. The processor 230 may control the abort handler 260 to perform abort handling with respect to an abort command received at a preset arbitrary timing. Such an operation will be described below in detail with reference to the accompanying drawings.

The RAM 240 may be configured as a random-access memory such as a dynamic RAM (DRAM) or a static RAM (SRAM). The RAM 240 may store software driven through the processor 230. The RAM 240 may store data required for the driving of the software. For example, the RAM 240 may be operated as a working memory of the processor 230.

When the nonvolatile memory device 100 is configured as a flash memory device, the processor 230 may control an internal operation of the nonvolatile memory device 100 and drive software which is known as a flash translation layer (FTL) for providing device compatibility to a host apparatus. Through the driving of the flash translation layer (FTL), the host apparatus may use the data storage apparatus 10 by recognizing the data storage apparatus 10 as a general data storage apparatus such as a hard disc.

The flash translation layer (FTL) may be loaded into the RAM 240 and may be configured as modules configured to perform various functions and meta data required for the driving of the modules. For example, the flash translation layer (FTL) may include a ware-leveling module, a bad block management module, a garbage collection module, an interleaving module, a sudden power-off management module, an address map, and the like. It is noted, however, that the configuration of the flash translation layer (FTL) is not limited thereto.

The RAM 240 may include a data buffer DB in which data (for example, write data) which is received from a host apparatus and is to be transmitted to the nonvolatile memory device 100 and data (for example, read data) which is read out from the nonvolatile memory device 100 and is to be transmitted to the host apparatus are temporarily stored. Although not specifically shown in FIG. 1, the data buffer DB may include a write data buffer in which the write data is temporarily stored and a read data buffer in which the read data is temporarily stored.

The buffer manager 250 may be configured to manage the data buffer DB. For example, the buffer manager 250 may manage the data buffer DB so that the write data or the read data temporarily stored in the data buffer DB is transmitted to the nonvolatile memory device 100 or a host apparatus. The buffer manager 250 may manage the data buffer DB so that data corresponding to a normal command to be aborted due to an abort command among the data temporarily stored in the data buffer DB is deleted. The buffer manager 250 may change an index of a location in which the data is deleted in the data buffer DB due to the abort command. The index corresponding to the deleted data may be an index allocated to the deleted data and thus an index of data to be subsequently stored may be newly allocated and the new index allocation may be managed through the buffer manager 250.

The abort handler 260 may perform abort handling in response to an abort command through control of the processor 230. For example, when an abort handling instruction is transmitted from the processor 230 in response to an abort command, the abort handler 260 may determine whether or not one or more abort commands are queued in the abort command queue ACMDQ by scanning the abort command queue ACMDQ of the command queue 220.

When a queued abort command is not present, the abort handler 260 may report to the processor 230 that the performing of the abort handling is unnecessary. When the report that the performing of the abort handling is unnecessary is received from the abort handler 260, the processor 230 may control the overall operation of the data storage apparatus 10 so that the subsequent operations are performed.

When one or more queued abort commands are present, the abort handler 260 may perform abort handling with respect to the normal commands, which are targets of the abort commands. The abort handling may include a series of operations of deleting the target normal commands from the normal command queue NCMDQ of the command queue 220 or a memory command buffer MCMDB included in the memory interface 270, deleting data (for example, write data or read data) corresponding to the deleted normal commands from the data buffer DB, and changing indexes for locations in which the data are deleted in the data buffer DB.

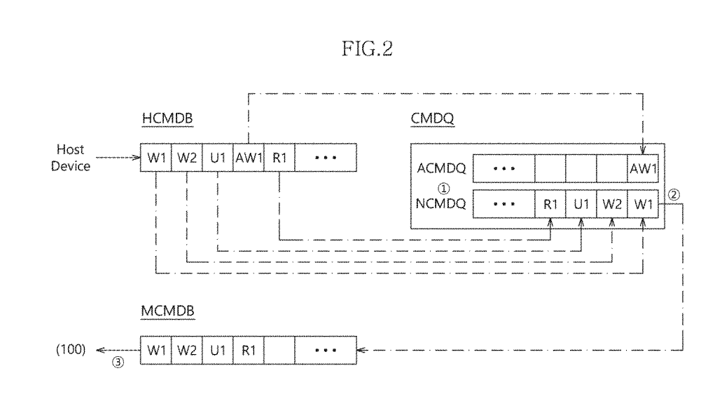

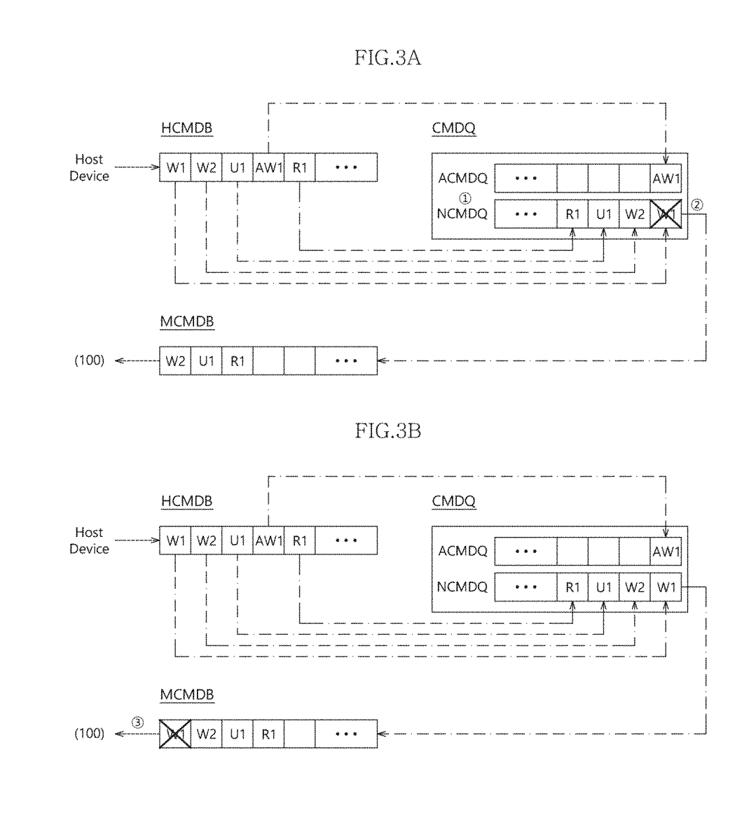

FIG. 2 is a simplified diagram illustrating a command transmission process and FIGS. 3A and 3B are simplified diagrams illustrating examples that a location in which an abort-requested command is deleted is changed according to an abort handling instruction timing. In FIGS. 2 to 3B, the reference letters “W”, “U”, and “R” may indicate “write command”, “unmap command”, and “read command”, respectively and the reference numerals “1” and “2” after the letters may indicate an order of the command reception. The reference letter “A” indicates an “abort command”. For example, “AW1” may indicate the abort command for requesting aborting for a first write command W1”.

Referring to FIG. 2, the commands received from a host apparatus may be stored according to a reception order thereof in the host command buffer HCMDB of the host interface 210. The commands stored in the host command buffer HCMDB may be transmitted to the command queue 220 in the order of the command reception.

As described above, the command queue 220 may include the normal command queue NCMDQ in which the normal commands are queued and the abort command queue ACMDQ in which the abort commands are queued. The commands transmitted from the host command buffer HCMDB may be queued in the normal command queue NCMDQ or the abort command queue ACMDQ according to whether the commands are normal or abort commands. The normal commands, for example, “W1”, “U1”, “W2”, and “R1” queued in the normal command queue NCMDQ of the command queue 220 may be dequeued from the normal command queue NCMDQ according to the queued order and stored in the memory command buffer MCMDB of the memory interface 270. Memory commands stored in the memory command buffer MCMDB may be transmitted to the nonvolatile memory device 100. The memory commands stored in the memory command buffer MCMDB may be commands generated in a command generator (not shown) based on the normal commands dequeued from the normal command queue NCMDQ as described above.

The processor 230 may rearrange the normal commands queued in the normal command queue NCMDQ of the command queue 220 according to their priority. The operation of rearranging the queued commands has been already well-known in the related art and is not relevant to the main features of the present disclosure and thus detailed description therefore will be omitted.

The processor 230 may instruct the abort handler 260 to perform abort handling at a timing [symbol] before the normal commands W1, U1, W2, and R1 queued in the normal command queue NCMDQ are rearranged or at a timing [symbol] before the normal commands W1, U1, W2, and R1 are dequeued after the rearrangement. When the abort handling instruction is received from the processor 230, the abort handler 260 may determine whether or not the queued abort command is present by scanning the abort command queue ACMDQ of the command queue 220.

When an abort command is not present, the abort handler 260 may provide the report that the abort handling is unnecessary to the processor 230. When the report that the abort handling is unnecessary is received from the abort handler 260, the processor 230 may control the data storage apparatus 10 to perform the following operation. For example, the processor 230 may determine that commands to be aborted are not present among the normal commands W1, U1, W2, and R1 queued in the normal command queue NCMDQ and dequeue the normal commands to be transmitted to the memory command buffer MCMDB.

When an abort command is present, the abort handler 260 may determine a current location of the normal command as a target of the abort command “AW1”. It is assumed that the normal command W1 is the target of the abort command AW1. For example, when the abort handling instruction timing of the processor 230 is the timing [symbol] before the normal commands W1, U1, W2, and R1 are dequeued after rearranging the normal commands W1, U1, W2, and R1, the abort handler 260 may determine that the current location of the normal command W1 as the target of the abort command AW1 is the normal command queue NCMDQ. Accordingly, as illustrated in FIG. 3A, the abort handler 260 may delete the normal command W1 corresponding to the abort command AW1 from the normal command queue NCMDQ and may not transmit the deleted normal command W1 to the memory command buffer MCMDB.

The processor 230 may instruct the abort handler 260 to perform the abort handling at a timing [symbol] before the commands W1, U1, W2, and R1 stored in the memory command buffer MCMDB are transmitted to the nonvolatile memory device 100. The abort handler 260 may determine that the current location of the normal command W1 corresponding to the abort command AW1 is the memory command buffer MCMDB through the same method as the above-described method. Accordingly, as illustrated in FIG. 3B, the abort handler 260 may delete the normal command W1 corresponding to the abort command AW1 from the memory command buffer MCMDB and may not transmit the deleted normal command W1 to the nonvolatile memory device 100.

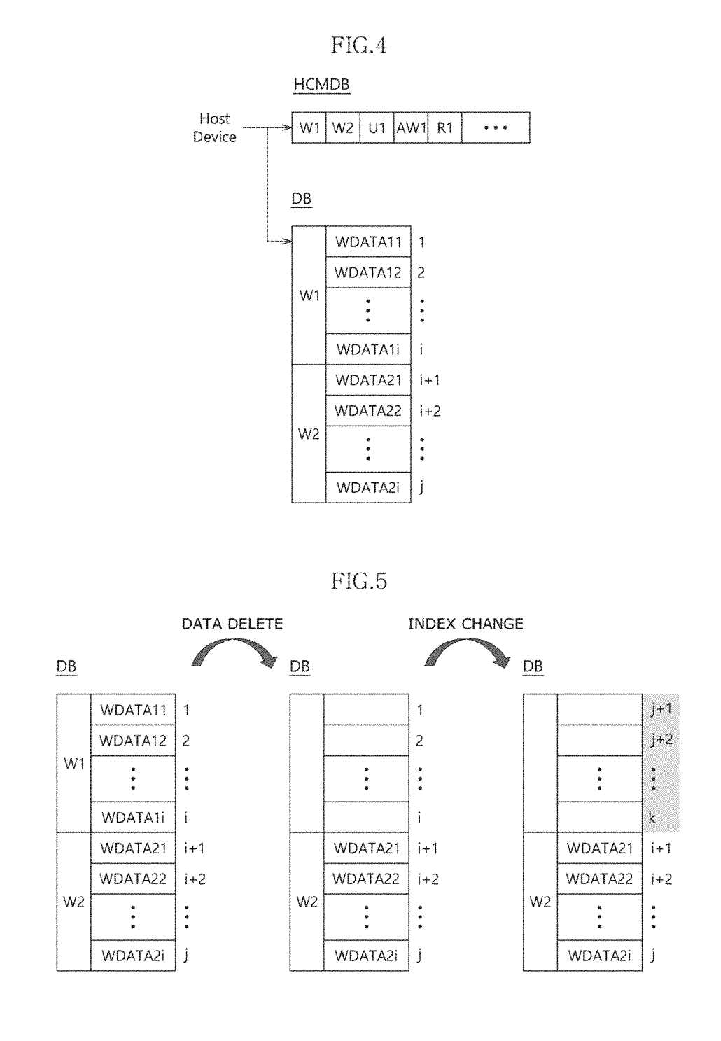

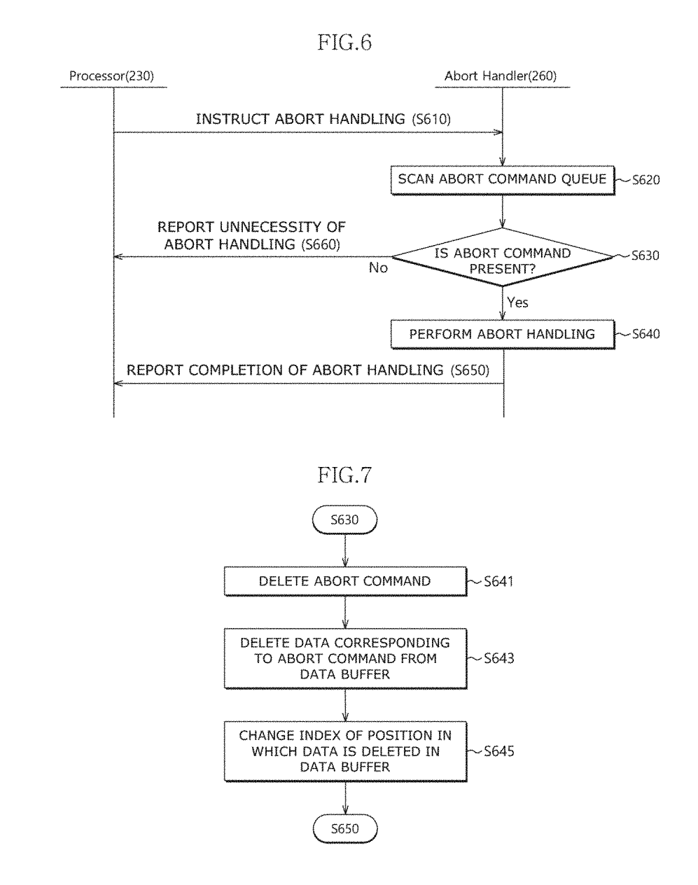

FIG. 4 is a simplified diagram illustrating an example that write data corresponding to a write command is stored in the data buffer DB and FIG. 5 is a simplified diagram illustrating an example that data stored in the data buffer DB is deleted and the index of the deleted data is changed by the performing of the abort handling. For clarity, it has been illustrated in FIGS. 4 and 5 that the data buffer DB is a write data buffer in which the write data is stored and the data buffer DB has a size in which j numbers of data are stored. Denotation “1” to “j” at a side of the data buffer DB may indicate indexes for the stored write data in FIGS. 4 and 5.

When the write command is received from a host apparatus, the write data corresponding to the write command may be received with the write command and the received write data may be temporarily stored in the data buffer DB of the RAM 240. The indexes for locations into which the write data is stored in the data buffer DB may be set and changed through the buffer manager 250.

The indexes for the locations in the data buffer DB may be increased whenever new data is stored in the data buffer DB, but this is not limited thereto.

As illustrated in FIG. 4, when the first write command W1 and the second write command W2 are sequentially transmitted from a host apparatus and stored in the host command buffer HCMDB, first write data WDATA11 to WDATA1i corresponding to the first write command W1 and second write data WDATA21 to WDATA2i corresponding to the second write command W2 may also be sequentially stored in the data buffer DB. Indexes “1” to “i” may be corresponding to the first write data WDATA11 to WDATA1i and indexes “i+1” to “j” may be corresponding to the second write data WDATA21 to WDATA2i.

According to the abort handling instruction of the processor 230, the abort handler 260 may delete the normal command W1 corresponding to the abort command AW1 from the normal command queue NCMDQ or the memory command buffer MCMDB as illustrated in FIGS. 3A and 3B and simultaneously delete the first write data WDATA11 to WDATA1i stored in the data buffer DB using the buffer manager 250 as illustrated in FIG. 5. As the first write data WDATA11 to WDATA1i are deleted, the indexes (for example, “1” to “i”) allocated to the first write data WDATA11 to WDATA1i may be necessary to be changed. The abort handler 260 may change the indexes “1” to “i” for the locations in which the first write data WDATA11 to WDATA1i are stored in the data buffer DB to indexes “j+1” to “k” using the buffer manager 250. Then, the data received from the host apparatus may be sequentially stored in the locations of which the indexes are changed.

In the embodiment, the abort command may not be processed through an interrupt manner but may be processed at a timing based on the determination of the processor 230 using the abort handler 260 separately provided. For example, in the embodiment, the controller 200 may determine the performing timing of the abort handling and thus the problem that the synchronization between the various function modules inside the controller 200 of the data storage apparatus 10 or the various function modules inside the nonvolatile memory device 100 is broken may be prevented.

The memory interface 270 may control the nonvolatile memory device 100 according to control of the processor 230. The memory interface 270 may also be referred to as a memory device controller. The memory interface 270 may provide control signals to the nonvolatile memory device 100. The control signals may include a command, an address, and the like for controlling the nonvolatile memory device 100. The memory interface 270 may provide data to the nonvolatile memory device 100 or receive data from the nonvolatile memory device 100. The memory interface 270 may be coupled to the nonvolatile memory device 100 through a channel CH. The channel may include one or more signal lines.

The memory interface 270 may include the memory command buffer MCMDB. Although not shown in FIG. 1, the controller 200 may include a command generator (not shown) configured to generate memory commands to be transmitted to the nonvolatile memory device 100 based on the normal commands queued in the normal command queue NCMDQ of the command queue 220. The processor 230 may generate the memory commands using the command generator and the memory commands generated in the command generator may be stored in the memory command buffer MCMDB of the memory interface 270. The memory command buffer MCMDB may have a FIFO structure.

FIG. 6 is s flowchart illustrating an operating method of a data storage apparatus in accordance with an embodiment of the present disclosure. FIG. 7 is a detailed flowchart illustrating operation S640 of FIG. 6. The operating method of a data storage apparatus in accordance with an embodiment will be described with reference to FIGS. FIGS. 1 to 7.

In operation S610, the processor (see 230 of FIG. 1) of the controller (see 200 of FIG. 1) may instruct the abort handler 260 to perform abort handling.

In operation S620, the abort handler 260 may scan the abort command queue ACMDQ of the command queue 220.

In operation S630, the abort handler 260 may determine whether or not an abort command queued in the abort command queue ACMDQ is present. When an abort command queued in the abort command queue ACMDQ is present, the processor may proceed to operation S640.

In operation 640, the abort handler 260 may perform abort handling with respect to the abort command. The detailed operation of the abort handling will be described with reference to FIG. 7.

In operation S641, the abort handler 260 may delete the normal commands corresponding to the abort command. For example, when the abort handling instruction timing of the processor 230 is a timing before the normal commands queued in the normal command queue NCMDQ are rearranged or a timing before the normal commands are dequeued from the normal command queue NCMDQ, the abort handler 260 may delete the normal command corresponding to the abort command from the normal command queue NCMDQ. When the abort handling instruction timing of the processor 230 is a timing before the normal commands stored in the memory command buffer MCMDB are transmitted to the nonvolatile memory device 100, the abort handler 260 may delete the normal command corresponding to the abort command from the memory command buffer MCMDB.

In operation S643, the abort handler 260 may delete the data corresponding to the deleted normal command from the data buffer DB using the buffer manager 250. When the deleted normal command is the write command, the abort handler 260 may delete the corresponding write data from the write data buffer of the data buffer DB. When the deleted normal command is a read command and before the data corresponding to the corresponding read command is read out from the nonvolatile memory device 100, the data to be deleted from the read data buffer of the data buffer DB may not be present.

In operation S645, the abort handler 260 may change indexes for locations of data deleted from the data buffer DB using the buffer manager 250. When the change of the indexes is completed, the abort handling for the abort command may be completed.

In operation S650, the abort handler 260 may provide a report that the abort handling is completed to the processor 230. When the report that the abort handling is completed is received, the processor 230 may control the data storage apparatus 10 to perform the following operation.

In operation S630, when the abort command queued in the abort command queue ACMDQ is not present, the processor 230 may proceed to operation S660.

In operation S660, the abort handler 260 may provide a report that the abort handling is unnecessary to the processor 230. The processor 230 may control the data storage apparatus 10 to perform the following operation when the report that the abort handling is unnecessary is received.

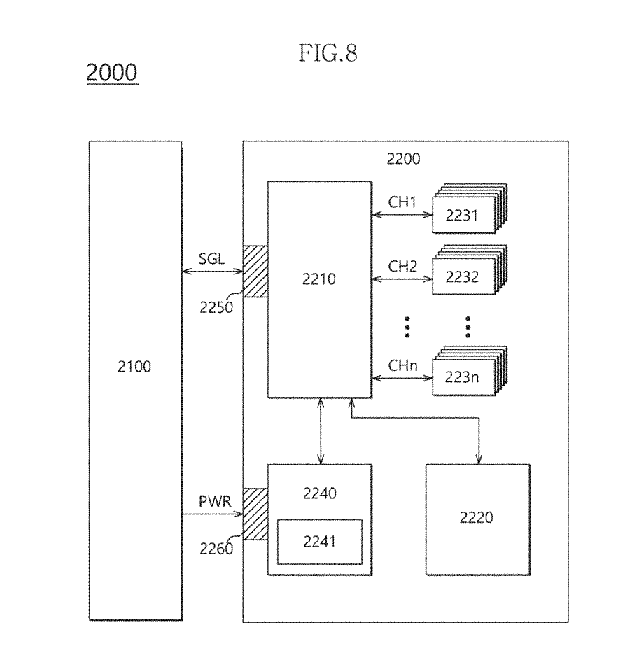

FIG. 8 is a simplified diagram illustrating an example of a data processing system including a solid-state drive (SSD) in accordance with an embodiment. Referring to FIG. 8, a data processing system 2000 may include a host apparatus 2100 and an SSD 2200.

The SSD 2200 may include a controller 2210, a buffer memory device 2220, nonvolatile memory devices 2231 to 223n, a power supply 2240, a signal connector 2250, and a power connector 2260.

The controller 2210 may control an overall operation of the SSD 2220.

The buffer memory device 2220 may temporarily store data to be stored in the nonvolatile memory devices 2231 to 223n. The buffer memory device 2220 may temporarily store data read from the nonvolatile memory devices 2231 to 223n. The data temporarily stored in the buffer memory device 2220 may be transmitted to the host apparatus 2100 or the nonvolatile memory devices 2231 to 223n according to control of the controller 2210.

The nonvolatile memory devices 2231 to 223n may be used as a storage medium of the SSD 2200. The nonvolatile memory devices 2231 to 223n may be coupled to the controller 2210 through a plurality of channels CH1 to CHn. One or more nonvolatile memory devices may be coupled to one channel. The nonvolatile memory devices coupled to the one channel may be coupled to the same signal bus and the same data bus.

The power supply 2240 may provide power PWR input through the power connector 2260 to the inside of the SSD 2200. The power supply 2240 may include an auxiliary power supply 2241. The auxiliary power supply 2241 may supply the power so that the SSD 2200 is normally terminated even when sudden power-off occurs. The auxiliary power supply 2241 may include large capacity capacitors capable of charging the power PWR.

The controller 2210 may exchange a signal SGL with the host apparatus 2100 through the signal connector 2250. The signal SGL may include a command, an address, data, and the like. The signal connector 2250 may be configured as various types of connectors according to an interfacing method between the host apparatus 2100 and the SSD 2200.

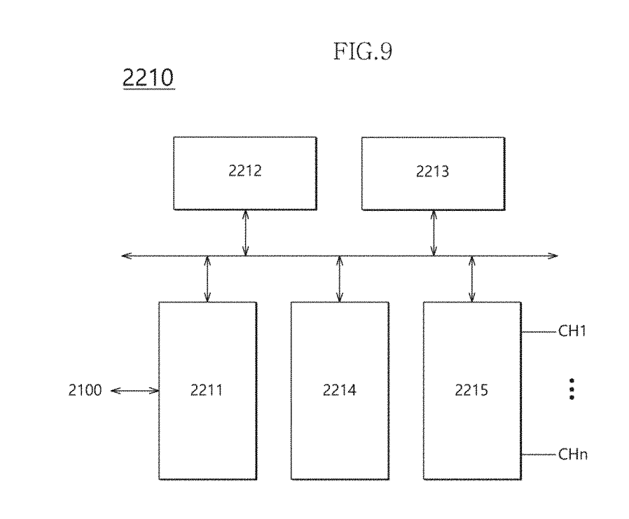

FIG. 9 is a simplified diagram illustrating an example of the controller 2210 of FIG. 8. Referring to FIG. 9, the controller 2210 may include a host interface unit 2211, a control unit 2212, a random-access memory (RAM) 2213, an error correction code (ECC) unit 2214, and a memory interface unit 2215. The control unit 2212, the host interface unit 2211, the memory interface 2215, and the memory RAM 2213 may correspond to the processor 230, the host interface 210, the memory interface 270, and the RAM 240 of FIG. 1, respectively. The host interface unit 2211 may perform interfacing between the host apparatus 2100 and the SSD 2200 according to a protocol of the host apparatus 2100. For example, the host interface unit 2211 may communicate with the host apparatus 2100 through any one among a secure digital protocol, a universal serial bus (USB) protocol, a multimedia card (MMC) protocol, an embedded MMC (eMMC) protocol, a personal computer memory card international association (PCMCIA) protocol, a parallel advanced technology attachment (PATA) protocol, a serial advanced technology attachment (SATA) protocol, a small computer system interface (SCSI) protocol, a serial attached SCSI (SAS) protocol, a peripheral component interconnection (PCI) protocol, a PCI Express (PCI-E) protocol, and a universal flash storage (UFS) protocol. The host interface unit 2211 may perform a disc emulation function that the host apparatus 2100 recognizes the SSD 2200 as a general-purpose data storage apparatus, for example, a hard disc drive HDD.

The control unit 2212 may analyze and process the signal SGL input from the host apparatus 2100. The control unit 2212 may control operations of internal functional blocks according to firmware and/or software for driving the SDD 2200. The RAM 2213 may be operated as a working memory for driving the firmware or software.

The ECC unit 2214 may generate parity data for the data to be transferred to the nonvolatile memory devices 2231 to 223n. The generated parity data may be stored in the nonvolatile memory devices 2231 to 223n together with the data. The ECC unit 2214 may detect errors for data read from the nonvolatile memory devices 2231 to 223n based on the parity data. When detected errors are within a correctable range, the ECC unit 2214 may correct the detected errors.

The memory interface unit 2215 may provide a control signal such as a command and an address to the nonvolatile memory devices 2231 to 223n according to control of the control unit 2212. The memory interface unit 2215 may exchange data with the nonvolatile memory devices 2231 to 223n according to control of the control unit 2212. For example, the memory interface unit 2215 may provide data stored in the buffer memory device 2220 to the nonvolatile memory devices 2231 to 223n or provide data read from the nonvolatile memory devices 2231 to 223n to the buffer memory device 2220.

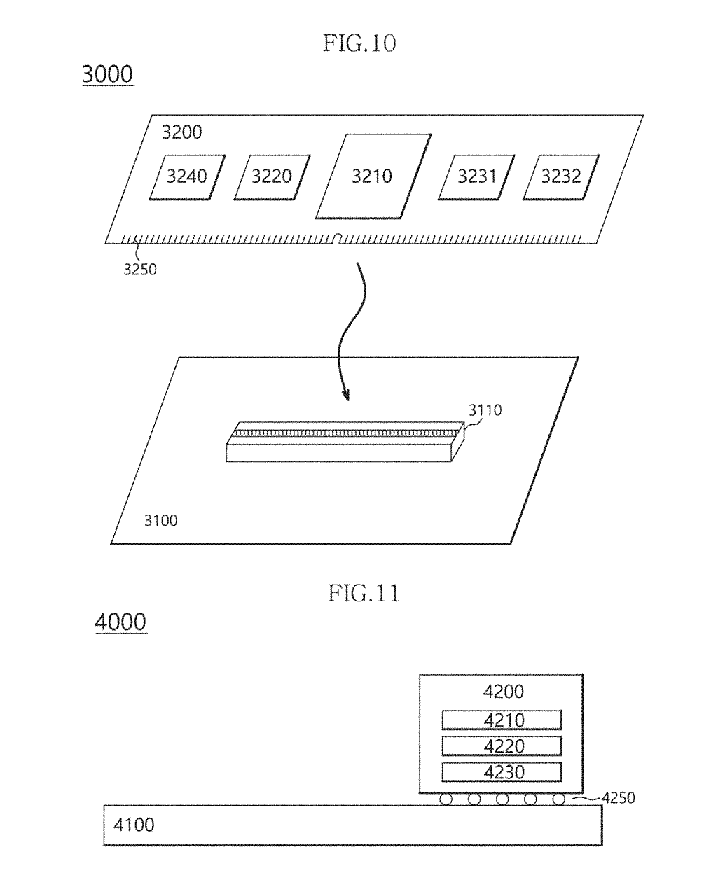

FIG. 10 is a simplified diagram illustrating an example of a data processing system including a data storage apparatus in accordance with an embodiment. Referring to FIG. 10, a data processing system 3000 may include a host apparatus 3100 and a data storage apparatus 3200.

The host apparatus 3100 may be configured in a board form such as a printed circuit board (PCB). Although not shown in FIG. 10, the host apparatus 3100 may include internal functional blocks configured to perform functions of the host apparatus 3100.

The host apparatus 3100 may include a connection terminal 3110 such as a socket, a slot, or a connector. The data storage apparatus 3200 may be mounted on the connection terminal 3110.

The data storage apparatus 3200 may be configured in a board form such as a PCB. The data storage apparatus 3200 may refer to a memory module or a memory card. The data storage apparatus 3200 may include a controller 3210, a buffer memory device 3220, nonvolatile memory devices 3231 to 3232, a power management integrated circuit (PMIC) 3240, and a connection terminal 3250.

The controller 3210 may control an overall operation of the data storage apparatus 3200. The controller 3210 may be configured to have the same configuration as the controller 2210 illustrated in FIG. 9.

The buffer memory device 3220 may temporarily store data to be stored in the nonvolatile memory devices 3231 and 3232. The buffer memory device 3220 may temporarily store data read from the nonvolatile memory devices 3231 and 3232. The data temporarily stored in the buffer memory device 3220 may be transmitted to the host apparatus 3100 or the nonvolatile memory devices 3231 and 3232 according to control of the controller 3210.

The nonvolatile memory devices 3231 and 3232 may be used as a storage medium of the data storage apparatus 3200.

The PMIC 3240 may provide power input through the connection terminal 3250 to the inside of the data storage apparatus 3200. The PMIC 3240 may manage the power of the data storage apparatus 3200 according to control of the controller 3210.

The connection terminal 3250 may be coupled to the connection terminal 3110 of the host apparatus 3100. A signal such as a command, an address, and data and power may be transmitted between the host apparatus 3100 and the data storage apparatus 3200 through the connection terminal 3250. The connection terminal 3250 may be configured in various forms according to an interfacing method between the host apparatus 3100 and the data storage apparatus 3200. The connection terminal 3250 may be arranged in any one side of the data storage apparatus 3200.

FIG. 11 is a simplified diagram illustrating an example of a data processing system including a data storage apparatus in accordance with an embodiment. Referring to FIG. 11, a data processing system 4000 may include a host apparatus 4100 and a data storage apparatus 4200.

The host apparatus 4100 may be configured in a board form such as a PCB. Although not shown in FIG. 11, the host apparatus 4100 may include internal functional blocks configured to perform functions of the host apparatus 4100.

The data storage apparatus 4200 may be configured in a surface mounting packaging form. The data storage apparatus 4200 may be mounted on the host apparatus 4100 through a solder ball 4250. The data storage apparatus 4200 may include a controller 4210, a buffer memory device 4220, and a nonvolatile memory device 4230.

The controller 4210 may control an overall operation of the data storage apparatus 4200. The controller 4210 may be configured to have the same configuration as the controller 2210 illustrated in FIG. 9.

The buffer memory device 4220 may temporarily store data to be stored in the nonvolatile memory device 4230. The buffer memory device 4220 may temporarily store data read from the nonvolatile memory device 4230. The data temporarily stored in the buffer memory device 4220 may be transmitted to the host apparatus 4100 or the nonvolatile memory device 4230 through control of the controller 4210.

The nonvolatile memory device 4230 may be used as a storage medium of the data storage apparatus 4200.

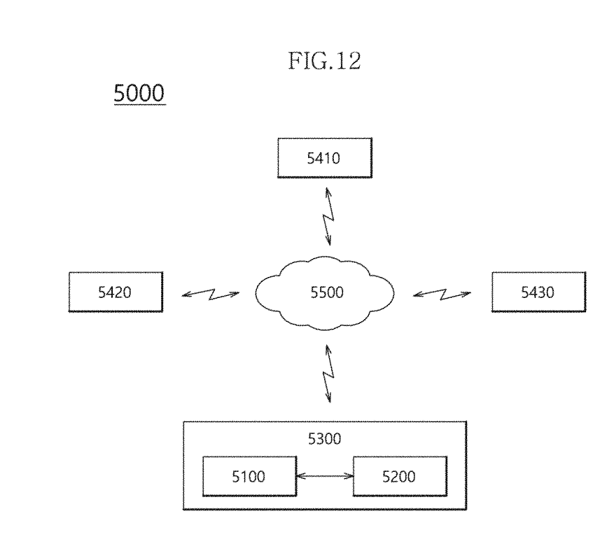

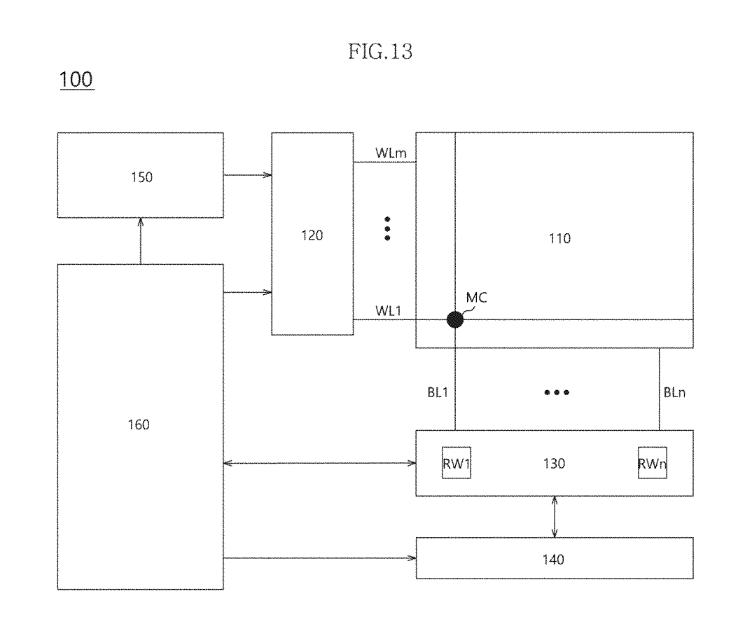

FIG. 12 is a simplified diagram illustrating an example of a network system 5000 including a data storage apparatus in accordance with an embodiment. Referring to FIG. 12, the network system 5000 may include a server system 5300 and a plurality of client systems 5410 to 5430 which are coupled through a network 5500.

The server system 5300 may serve data in response to requests of the plurality of client systems 5410 to 5430. For example, the server system 5300 may store data provided from the plurality of client systems 5410 to 5430. In another example, the server system 5300 may provide data to the plurality of client systems 5410 to 5430.

The server system 5300 may include a host apparatus 5100 and a data storage apparatus 5200. The data storage apparatus 5200 may be configured as the data storage apparatus 10 of FIG. 1, the data storage apparatus 2200 of FIG. 8, the data storage apparatus 3200 of FIG. 10, or the data storage apparatus 4200 of FIG. 11.

FIG. 12 is simplified block diagram illustrating an example of a nonvolatile memory device included in a data storage apparatus in accordance with an embodiment. Referring to FIG. 12, a nonvolatile memory device 100 may include a memory cell array 110, a row decoder 120, a column decoder 140, a data read/write block 130, a voltage generator 150, and a control logic 160.

The memory cell array 110 may include memory cells MC arranged in regions in which word lines WL1 to WLm and bit lines BL1 to BLn cross to each other.

The row decoder 120 may be coupled to the memory cell array 110 through the word lines WL1 to WLm. The row decoder 120 may operate through control of the control logic 160. The row decoder 120 may decode an address provided from an external apparatus (not shown). The row decoder 120 may select and drive the word lines WL1 to WLm based on a decoding result. For example, the row decoder 120 may provide a word line voltage provided from the voltage generator 150 to the word lines WL1 to WLm.

The data read/write block 130 may be coupled to the memory cell array 110 through the bit lines BL1 to BLn. The data read/write block 130 may include read/write circuits RW1 to RWn corresponding to the bit lines BL1 to BLn. The data read/write block 130 may operate according to control of the control logic 160. The data read/write block 130 may operate as a write driver or a sense amplifier according to an operation mode. For example, the data read/write block 130 may operate as the write driver configured to store data provided from an external apparatus in the memory cell array 110 in a write operation. In another example, the data read/write block 130 may operate as the sense amplifier configured to read data from the memory cell array 110 in a read operation.

The column decoder 140 may operate though control of the control logic 160. The column decoder 140 may decode an address provided from an external apparatus (not shown). The column decoder 140 may couple the read/write circuits RW1 to RWn of the data read/write block 130 corresponding to the bit lines BL1 to BLn and data input/output (I/O) lines (or data I/O buffers) based on a decoding result.

The voltage generator 150 may generate voltages used for an internal operation of the nonvolatile memory device 100. The voltages generated through the voltage generator 150 may be applied to the memory cells of the memory cell array 110. For example, a program voltage generated in a program operation may be applied to word lines of memory cells in which the program operation is to be performed. In another example, an erase voltage generated in an erase operation may be applied to well regions of memory cells in which the erase operation is to be performed. In another example, a read voltage generated in a read operation may be applied to word lines of memory cells in which the read operation is to be performed.

The control logic 160 may control an overall operation of the nonvolatile memory device 100 based on a control signal provided from an external apparatus. For example, the control logic 160 may control an operation of the nonvolatile memory device 100 such as a read operation, a write operation, an erase operation of the nonvolatile memory device 100.

The above described embodiments of the present invention are intended to illustrate and not to limit the present invention. Various alternatives and equivalents are possible. The invention is not limited by the embodiments described herein. Nor is the invention limited to any specific type of semiconductor device. Other additions, subtractions, or modifications are obvious in view of the present disclosure and are intended to fall within the scope of the appended claims.

What is claimed is:

1. A data storage apparatus comprising:
a nonvolatile memory;
a command queue configured to queue one or more normal commands and an abort command;
a data buffer configured to temporarily store write data which is to be transmitted from the host apparatus to the nonvolatile memory device and read data which is read out from the nonvolatile memory device and is to be transmitted to the host apparatus;
an abort handler configured to perform abort handling with respect to a normal command corresponding to the abort command among the normal commands; and
a processor configured to instruct the abort handler to perform the abort handling before the normal commands are transmitted to the nonvolatile memory device.

2. The data storage apparatus of claim 1, further comprising a memory command buffer configured to sequentially store the normal commands dequeued from the command queue and provide stored normal commands to the nonvolatile memory device according to a stored order.

3. The data storage apparatus of claim 2, wherein the processor instructs the abort handler to perform the abort handling in at least a timing among a first timing before the normal commands queued in the command queue are rearranged, a second timing before the normal commands are dequeued from the command queue, and a third timing before the normal commands are provided from the memory command buffer to the nonvolatile memory device.

4. The data storage apparatus of claim 3, wherein when the abort handler is instructed to perform the abort handling at the first timing or the second timing from the processor, the abort handler determines whether or not a queued abort command is present by scanning the command queue and deletes a normal command corresponding to the queued abort command from the command queue.

5. The data storage apparatus of claim 4, wherein the abort handler deletes the normal command corresponding to the queued abort command from the command queue and then deletes data corresponding to a deleted normal command from the data buffer.

6. The data storage apparatus of claim 5, wherein the abort handler changes an index for a location in which the data is deleted from the data buffer.

7. The data storage apparatus of claim 3, wherein when the abort handler is instructed to perform the abort handling at the third timing from the processor, the abort handler determines whether or not a queued abort command is present by scanning the command queue and deletes a normal command corresponding to the queued abort command from the memory command buffer.

8. The data storage apparatus of claim 7, wherein the abort handler deletes the normal command corresponding to the queued abort command from the memory command buffer and then deletes data corresponding to a deleted normal command from the data buffer.

9. The data storage apparatus of claim 8, wherein the abort handler changes an index for a location in which the data is deleted from the data buffer.

10. The data storage apparatus of claim 1, wherein the command queue includes:
a normal command queue in which the normal commands are queued; and
an abort command queue in which the abort command is queued.

11. An operating method of a data storage apparatus including a nonvolatile memory device and a controller configured to control an operation of the nonvolatile memory device and to include a command queue, in which normal commands and an abort command are queued, and an abort handler configured to perform abort handling, the method comprising:
instructing the abort handler to perform the abort handling;
determining whether or not a queued abort command is present by scanning the command queue through the abort handler;
performing the abort handling with respect to a normal command corresponding to the abort command among the normal commands through the abort handler; and
providing a report that the abort handling is completed to the controller through the abort handler.

12. The method of claim 11, wherein the instructing of the abort handling to the abort handler is to be performed in at least a timing among a first timing before the normal commands queued in the command queue are rearranged, a second timing before the normal commands are dequeued from the command queue, and a third timing before the normal commands are output from a memory command buffer which receives the normal commands from the command queue and provides the normal commands to the nonvolatile memory device.

13. The method of claim 12, wherein the performing of the abort handling includes:
deleting the normal command corresponding to the abort command from the command queue or the memory command buffer;
deleting data related to a deleted normal command from a data buffer inside the controller; and
changing an index for a location in which the data is deleted from the data buffer.

14. A controller for controlling a memory system, the controller comprising:
a command queue suitable for queueing one or more commands;
a data buffer suitable for buffering data corresponding to the commands;
a command buffer suitable for buffering one or more commands; and
a processor suitable for:
rearranging the queued commands in the command queue;
de-queueing the rearranged commands to the command buffer;
outputting the buffered commands to control a memory device to perform an operation;
deleting one or more among the queued commands, the rearranged commands and the buffered commands indicated by an abort command; and
deleting the buffered data corresponding to the deleted commands.
